(19) United States
(12) Patent Application Publication
(10) Pub. No.: US 2003/0019849 A1
(43) Pub. Date: Jan. 30, 2003

(54) Electron beam gun with water cooled interlocking crucible cover

(76) Inventors: Daniel Barton Cameron, San Carlos, CA (US); Edward James Yuill, Reno, NV (US); Philip John Cooper, Lodi, CA (US); Christopher James Rainer, Stockton, CA (US)

Correspondence Address: CHA INDUSTRIES, 4201 BUSINESS CENTER DRIVE, FREMONT, CA, 94538, US

(21) Appl. No.: 09/906,948

(22) Filed: Jul. 16, 2001

(51) Int. Cl. B23K 15/00

(52) U.S. Cl. 219/121.27

(57) ABSTRACT

A crucible cover is used to stop, cross contamination of material, in the electron beam gun assembly, for evaporation of material in a vacuum chamber. The interlocking crucible cover stops cross contamination of the evaporated material, the angle of the crucible cover is below the line of sight of the evaporated material, to limit material build up for contamination, and the crucible cover is water cooled for mechanical stability.

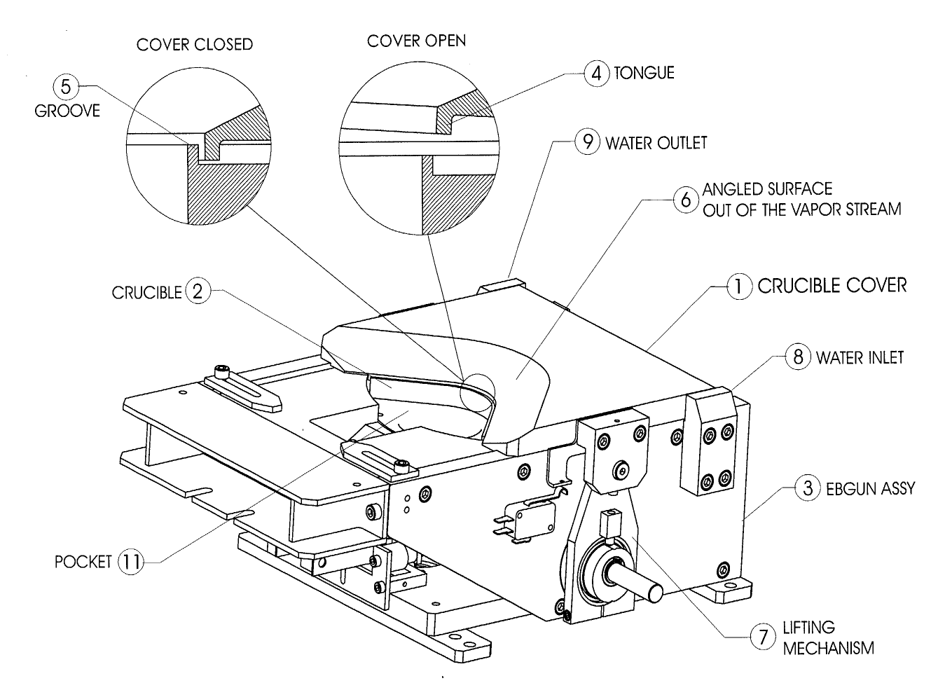

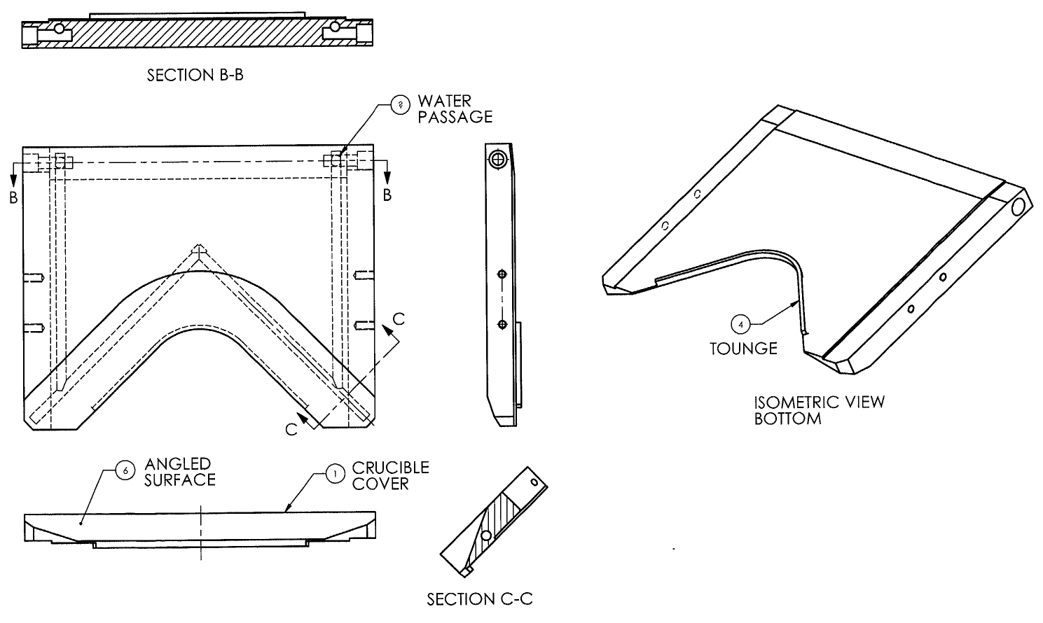

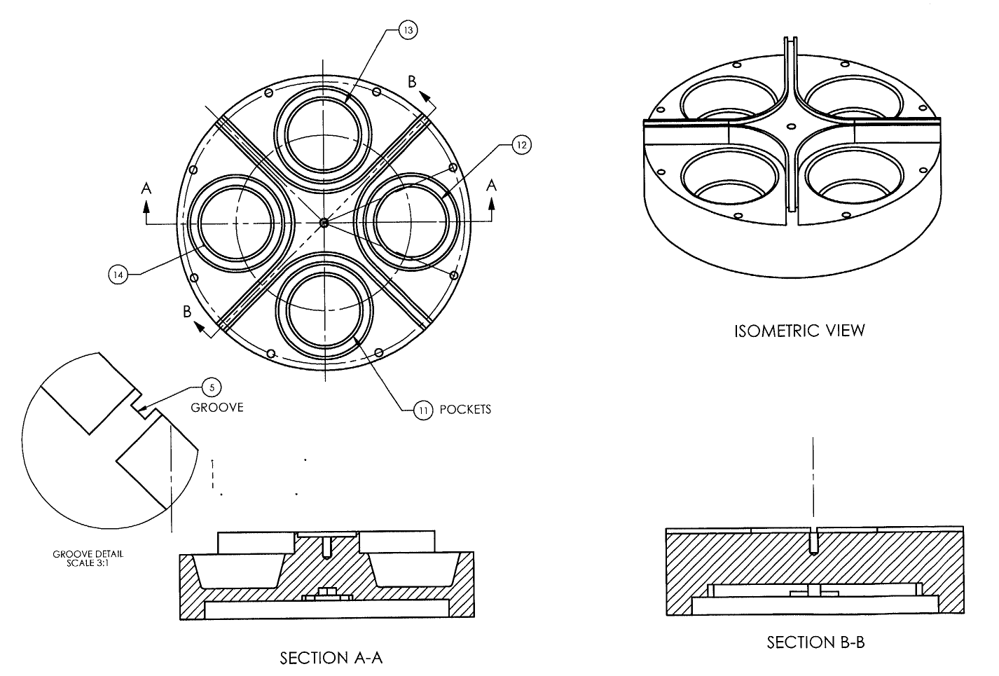

The invention relates to high vacuum evaporation and deposition systems, and more specifically to a device and method for the eliminating cross contamination and water cooling the crucible cover on an electron beam gun.

### BACKGROUND OF THE INVENTION

Electron beam guns have frequently been employed to evaporate material in a high vacuum environment for the purpose of ultimately depositing the material on a specific article or location. Such deposition systems typically include an electron beam gun emitting source, a crucible for holding the evaporant, and means for directing the electron beam onto the surface of the evaporant. Example of such systems are described in U.S. Pat. Nos. 3,710,072, 3,235,647, and 3,420,977.

Prior art devices that have a fixed crucible cover with a set clearance gap between the crucible and the crucible cover would allow for cross contamination from pocket to pocket. If the clearance is reduced the build up of evaporated material will cause the crucible to jam during rotation. A larger clearance gap to prevent jamming allows for greater cross contamination.

Another problem with prior electron beam guns is that the angle on the crucible cover is in the line of sight of the evaporate stream.

### SUMMARY OF THE INVENTION

It is the object of the present invention to eliminate the cross contamination between pockets of an electron beam gun, by removing the clearance gap between the crucible and the crucible cover, and by decreasing the angle on the leading edge of the crucible cover to stop the material build up from occurring during deposition, because the surface is not in the line of sight of the evaporate stream.

Another object of the invention is to provide an electron beam gun design in which the crucible cover is lifted to allow for crucible rotation.

Another object of the invention is to provide an electron beam gun design in which a crucible cover is water-cooled and can be moveable.

These and other objectives are achieved by water cooling, lifting the crucible cover, interlocking the cover with the crucible and keeping the leading edge of the cover out of the line of sight of the evaporate stream. The crucible cover has a tongue that goes into a groove on the crucible. This completely closes the clearance gap to zero, where we have a metal to metal contact. This contact area is completely out of the line of sight of the evaporate material. With the metal to metal contact we have eliminated the cross contamination because of the clearance gap. We raise and lower the crucible cover to allow for the crucible to rotate, exposing another pocket for material evaporation, during this operation you are no longer evaporating material. We also water cool the crucible cover for heat transfer and stability.

### DETAILED DESCRIPTION OF THE INVENTION

The preferred embodiment of the present invention, as best shown in drawing 90-1000 is comprised of and electron beam gun 3, which has attached to it the crucible cover 1, and the rotatable crucible 2. Both the crucible 2 and crucible cover 1 preferably will be made of oxygen free copper. The crucible cover 1 has a tongue 4, and is water-cooled. Water cooling to run through internal passages 10 (see on drawing 90-1107). The water is introduced through inlet 8 and exists through outlet 9. The angle 6 is out of the line of sight of the vapor stream. The crucible 2 has a groove section 5 around each of the pockets 11-14 (see drawing 90-1118).

The crucible cover 1 is raised and lowered using mechanism 7; this moves the tongue 4 in and out of the groove 5, allowing crucible 2 to be rotated.

The electron beam gun 3 is water-cooled, this water is then allowed to past through the crucible cover 1, from the inlet 8 and travels through water passage 10 and exists outlet 9. When tongue 4 of the crucible cover 1 is in place in groove 5 of the crucible 2 while evaporation is occurring there can't be any cross contamination of material between pocket 11 and the other pockets 12, 13, and 14. During this procedure water is cooling the crucible cover 1 through passage 10. The angled surface 6 is out of line of sight of the evaporated material.

Other means of lifting the crucible cover 1, for example and air cylinder are considered to be within the scope of the present invention.

Although the present invention has been shown and described with respect to preferred embodiments, various changes and modifications which are obvious to a person skilled in the art to which the invention pertains are deemed to lie within the spirit and scope of the invention.

### BRIEF DESCRIPTION OF DRAWINGS

Drawing 90-1107 shows the crucible cover with the water cooling passage and the Interlocking tongue.

Drawing 90-1 1 18 shows the crucible with the interlocking groove.

Drawing 90-1000 shows an electron beam gun assembly with the interlocking crucible Cover raised and lowered.

REFERENCE

| | | | |
|---|---|---|---|
| 5,111,022 | MAY 5, 1992 | Harper | 219/121.33 |
| 4,835,789 | May 30, 1989 | Hanks | 373/14 |
| 4,064,352 | Dec. 20, 1977 | Mann | 373/13 |
| 5,338,913 | Aug. 16, 1994 | Finn | 219/121.16 |
| 5,008,897 | Apr. 16, 1991 | Crumley | 373/11 |
| 4,866,239 | Sep. 12, 1989 | Equermeier | 373/11 |
| 3,483,417 | Dec. 1969 | Hanks | 219/121 |
| 3,406,934 | May 1969 | Hanks | 219/121 |

What is claimed is:

1. An electron beam gun, comprising:
A crucible and crucible cover which:
A crucible is comprised of multiple pockets which hold material to be evaporated.
Is water-cooled, interlocking with the crucible and with an angle which is below the line of sight of the vapor stream.
Wherein; the water-cooling is for the mechanical stability of the crucible cover and minimizes the surface evaporation from electron bombardment.
Wherein; the interlocking crucible cover with the crucible eliminates cross contamination from pocket to pocket. Lifting of the crucible cover allows for crucible rotation.
Wherein; the machined angle on the crucible cover is such that a minimum amount of evaporate is allowed to build up on the surface to prevent contamination from pocket to pocket.
